(19) United States
(12) Patent Application Publication
(10) Pub. No.: US 2025/0252329 A1
(43) Pub. Date: Aug. 7, 2025

(54) MEASURING AND VISUALIZING TOPIC MODEL TRAINING CONVERGENCE

(71) Applicant: Oracle International Corporation, Redwood City, CA (US)

(72) Inventor: Robert James Oberbreckling, Boulder, CO (US)

(21) Appl. No.: 18/435,996

(22) Filed: Feb. 7, 2024

(51) Int. Cl. G06N 7/01; G06F 18/2415

(52) U.S. Cl. CPC G06N 7/01; G06F 18/2415

(57) ABSTRACT

A topic modeling system may include a stability monitor to obtain topic probability distributions for vocabulary items for multiple topics during training iterations of a topic model. For a training iteration and topic, the stability monitor may select a top number of vocabulary elements according to a probability distribution of the topic for the training iteration and a previous training iteration, where the selected vocabulary elements have higher probabilities than vocabulary elements not selected. Then, using a similarity function, top vocabulary elements of the training iteration are compared to top vocabulary elements of the previous training iteration to generate a stability metric indicating an amount of similarity between the probability distributions of the training iteration and the previous training iteration. Additional metrics may be derived and the cumulative metrics may be used to analyze or visualize the convergence or divergence of training of individual topics of the topic model.

### BACKGROUND

### Field of the Disclosure

This disclosure relates generally to computer hardware and software, and more particularly to systems and methods for implementing machine learning systems for topic categorization.

### Description of the Related Art

Topic modeling using Latent Dirichlet Allocation (LDA) is a popular technique to learn, discover, and to explore prevailing themes in a collection of text documents. These techniques use unsupervised machine learning to automatically discover topics in collections of text documents. However, use of these unsupervised machine learning benefits from an ability to measure training progress of the machine learning system.

Popular measures of training progress over time typically include coarse summary scalar values over the whole model (e.g. perplexity computed on a held-out evaluation set). Some measures, like perplexity, require a representative evaluation set along with the computations to evaluate it. Furthermore, these model-level measures do not show lower per-topic-level properties.

### SUMMARY

Embodiments of systems and methods are disclosed herein that efficiently measure and assist in visualizing learning progress of topic modeling using Latent Dirichlet Allocation. The measurements are achieved objectively without an evaluation set and in sufficient detail such that overall model training progress can be observed while also seeing the training dynamics and interplay at an individual topic level. The measurements do not require selection of an effective and representative evaluation set, do not require the computational overhead associated with an evaluation set, are objective and do not require human expert judgment/agreement, work independently of any specific natural language, are problem domain independent and may apply to the many LDA problems outside of text, and is efficient, not requiring substantial computational resources.

A stability monitor may topic models' topic vocabulary distributions during training iterations of the models. For a training iteration and topic, the stability monitor may select a top number of elements according to a probability distribution of the topic for the training iteration and a previous training iteration, where the selected elements have higher probabilities of association than elements not selected. Then, using a similarity function, top elements of the training iteration are compared to top elements of the previous training iteration to generate a stability metric indicating an amount of similarity between the probability distributions of the training iteration and the previous training iteration. Additional metrics, such as rate of convergence, may be derived from the stability metrics and the cumulative metrics may be used to analyze or visualize the convergence or divergence of training of individual topics of the topic model.

### BRIEF DESCRIPTION OF THE DRAWINGS

FIG. 1 is a block diagram illustrating a topic modeling system implementing stability monitoring, according to various embodiments.

FIG. 2 is a sequence diagram illustrating training of a topic modeling system that implements stability monitoring, in various embodiments.

FIG. 3A is a diagram illustrating stability and convergence for a topic during training of a topic modeling system where the topic converges, in various embodiments.

FIG. 3B is a diagram illustrating stability and convergence for a topic during training of a topic modeling system where the topic fails to increasingly converge, in various embodiments.

FIG. 4 is a flow diagram illustrating an embodiment of determining respective stability metrics for topics of a topic model during training of the model, in some embodiments.

FIG. 5 is a block diagram illustrating one embodiment of a computing system that is configured to implement a topic modeling system that includes stability monitoring, as described herein.

FIG. 6 illustrates an example cloud computing environment whose resources may be employed to implement a topic modeling system that includes stability monitoring, according to at least some embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (e.g., meaning having the potential to) rather than the mandatory sense (e.g. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Topic modeling using Latent Dirichlet Allocation (LDA) is useful to learn, discover, and to explore prevailing themes in a collection of text documents. These techniques use unsupervised machine learning to automatically discover topics in collections of text documents. However, use of these unsupervised machine learning benefits from an ability to measure training progress of the machine learning system.

Popular measures of training progress over time typically include coarse summary scalar values over the whole model (e.g. perplexity computed on a held-out evaluation set). Some measures, like perplexity, require a representative evaluation set along with the computations to evaluate it. Furthermore, these model-level measures do not show lower per-topic-level properties.

Embodiments of systems and methods are disclosed herein that efficiently measure and assist in visualizing learning progress of topic modeling using Latent Dirichlet Allocation. The measurements are achieved objectively without an evaluation set and in sufficient detail such that overall model training progress can be observed while also seeing the training dynamics and interplay at an individual topic level. The measurements do not require selection of an effective and representative evaluation set, do not require the computational overhead associated with an evaluation set, are objective and do not require human expert judgment/agreement, work independently of any specific natural language, are problem domain independent and may apply to the many LDA problems outside of text, and is efficient, not requiring substantial computational resources.

These embodiments of systems and methods further solve secondary problems of omnipresent sampling noise in the training signal and potentially prohibitive computational overhead during training iterations. Thus, systems and methods are disclosed for implementing a topic modeling system that includes topic stability monitoring. The stability monitor may obtain topic probability distributions of vocabulary items, corresponding to words or other elements of document vocabulary, for multiple topics of the training documents during training iterations of a model. For a training iteration and topic, the stability monitor may select a top number of elements according to a probability distribution of the topic for the training iteration and a previous training iteration, where the selected elements have higher probabilities of association than elements not selected. Then, using a similarity function, top elements of the training iteration are compared to top elements of the previous training iteration to generate a stability metric indicating an amount of similarity between the probability distributions of the training iteration and the previous training iteration. Additional metrics, such as rate of convergence, may be derived from the stability metrics and the cumulative metrics may be used to analyze or visualize the convergence or divergence of training of individual topics of the topic model.

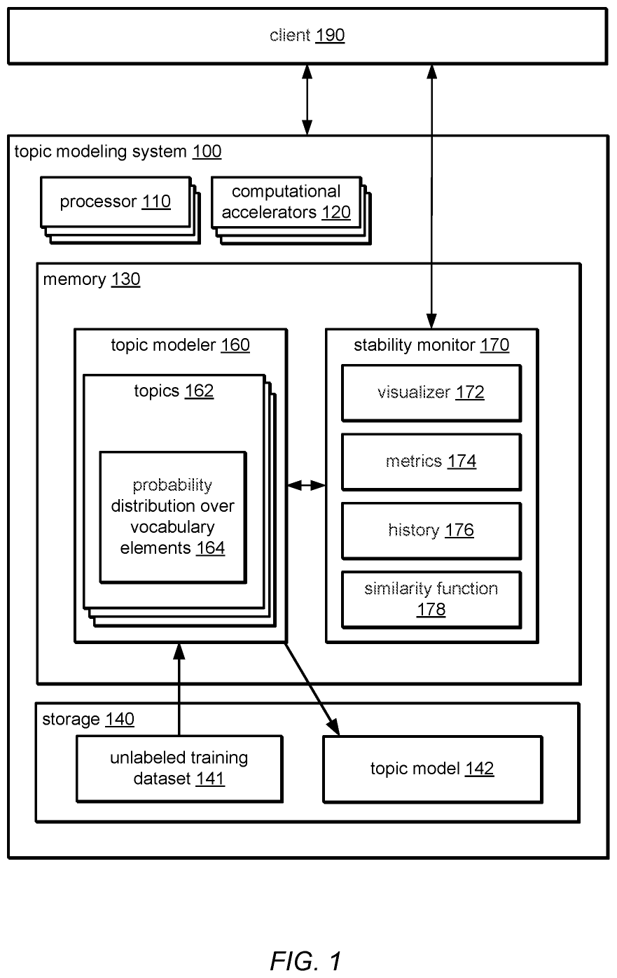

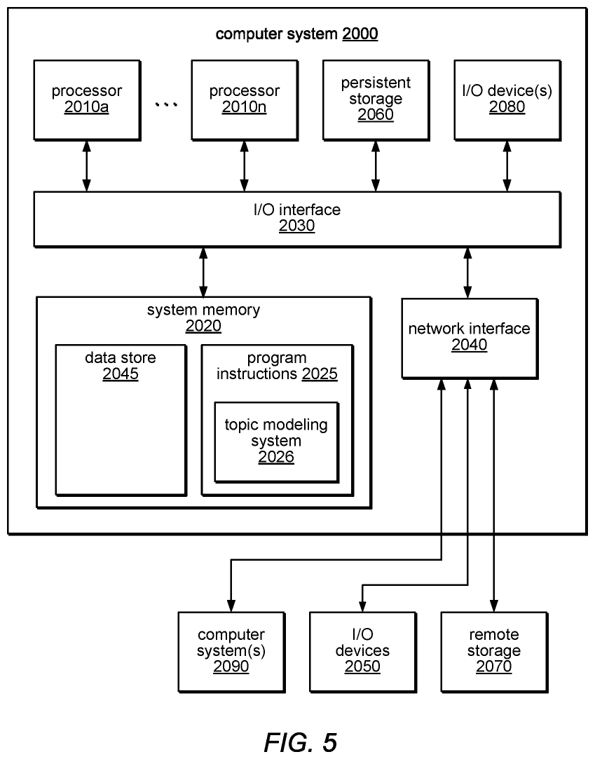

FIG. 1 is a block diagram illustrating a topic modeling system implementing stability monitoring, according to various embodiments. A topic modeling system 100 may be implemented using one or more computing nodes such as those discussed in greater below with regard to FIG. 5. The topic modeling system 100 may include one or more processors 110 and memory 130 and optionally include one or more computational accelerators 120. Examples of computational accelerators 120 may include graphics processing units (GPUs), although those of ordinary skill in the art will understand that this is merely one example and many types of computational accelerators may be imagined.

Furthermore, topic modeling system 100 may be implemented using distributed system embodiments or any of components may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular API to which other systems may be expected to conform when requesting the various operations.

Contained with the memory 130 of the topic modeling system 100 is all or part of a topic modeler 160. The topic modeler 160 may receive unlabeled training dataset(s) 141 to train topic modes models 142 for the topic modeling system 100. These training dataset(s) 141 and trained topic model(s) 142 may be stored in storage 140 which be locally attached to the computer node(s) implementing the topic modeling system 100 or be stored remotely on network-attached storage or as part of cloud storage provided by a service provider network that may provide machine learning services that incorporate the topic modeling system 100.

The topic modeler 160 may implement semantic indexing techniques, such as Latent Dirichlet Allocation (LDA). These techniques use unsupervised machine learning to automatically discover topics, such as topics 162, in collections of text documents such as represented in the unlabeled training dataset 141.

Latent Dirichlet Allocation, or LDA, models data, or documents, as including from multiple topics, where a topic is defined by a probability distribution over a fixed vocabulary of words or terms, these words or terms referred to as elements or tokens herein. In some embodiments, these words or terms may be tokenized from textual representations of the document vocabulary whereas in other embodiments documents may be non-textual and elements of the document vocabulary may be used directly. An example of non-textual vocabulary may be amino acids, where documents may represent genomes comprising these amino acids. Thus, it should be understood that topic modeling may, in various embodiments, be applicable, but not be constrained to, natural language processing any may include a variety of applications. It should be further understood that such applications are merely examples and are not intended to be limiting.

Individual topics 162 are defined by normalized probability distributions 164 of a vocabulary of elements. Using LDA, an initial assumption is made that training documents will represent a predetermined, fixed number of topics. This number may be determined in a variety of ways, for instance in some embodiments the number of topics may be determined proportional to the cumulative size of training documents. In other embodiments it may simply be set as an assumed constant or be specified by the user. In some embodiments, the number may be set by the user as a hyperparameter of the unsupervised training of the topic model. If too few topics are assumed, model training may fail to converge or otherwise be ineffective while if too many topics are assumed, model training may also be suboptimal or ineffective. While effective selection of the initial number of topics may be outside the scope of stability monitoring as disclosed herein, it should be understood that stability monitoring and the resulting metrics may, in some embodiments, may be exploited by a topic modeling system in some embodiments to provide feedback in the selection or tuning of topic count.

In various embodiments, LDA may assume that a collection of training documents are associated with the determined number of topics 162. and that each training document discusses various topics in different proportions. Topics are not known in advance but may be learned from training with the documents. Thus LDA provides a hidden variable model of documents where observed data interacts with hidden random variables. In LDA, the observed data are the tokenized vocabulary of each document and the hidden variables represent the various topics and how each document exhibits them. The relationships between the training documents including the observed data and the hidden topic structure is then determined with a probabilistic generative process involving iterative training, where the result of each training iteration is an evolving probability distribution 164 of elements for the predetermined number of topics 162.

An LDA model training iteration may traverse every word or element in every training document. And at each element, a currently and conditionally learned probability distribution of topics is sampled using sampling to assign a single topic to that element in the current document's context. This topic assignment to an element may be different from the previous training iteration's sampled topic assignment, or the assignment might be the same topic.

All of the training documents' elements are traversed and sampled for their topic assignment for as many training iterations as configured (this training iteration count is a configurable training hyper-parameter). There is a learning feedback mechanism which affects the sampling distributions from previous training iterations to “improve” the accuracy of the topic sampling in each success training iteration.

Because topic assignment entails probabilistic sampling, there is always a degree of sampling error (noise) in choosing and assigning topics to elements. In LDA theory, and in practice with reasonable data, as training iterations and topic sampling progress, the model should converge in the sense that each element's sampled topic assignment becomes more consistent, or duplicated more often, over time. I.e., the sampled topic assignment for each element should become relatively more stable with fewer topic assignment differences between training iterations as the model's topics are conditionally learned better over time, again albeit with sampling noise.

At the completion of a training iteration, for each topic, the counts of the topic/element assignments are normalized into a proper probability distribution over the model's fixed and known vocabulary. Note that the model vocabulary set for each topic is identical; only the learned probability distributions over that vocabulary differ for each topic. Each topic in the model is simply a learned distribution over the model's vocabulary.

The top-n most weighted (most probable) elements in any topic are said to be the most likely elements to “describe” or “characterize” that topic. Below those top-n descriptive elements, there may be a very long tail of progressively more down-weighted and less-probable vocabulary in the topic. Importantly, this long tail also demonstrates increasingly more sampling noise because sampling is always less confident there, by definition, even in later training iterations.

Framed in terms of counting topic assignment differences, measuring LDA model convergence initially appears to be as simple as counting every word's topic assignment differences across each successive training iteration. As training iterations progress, topic assignment differences would generally decrease as words' topic assignments become more consistent and change less. Counting all differences, however, only produces a single and opaque scalar “delta” measure, which has similar shortcomings to the popular perplexity measure scalar, and more unfortunately, the sampling at each word introduces a significant amount of sampling noise. By noise, this refers to the fact that a topic statistically sampled from the sampler is not always “correct”. Again, for each topic, there is the long tail of model element vocabulary that is deemed less probable and “less characteristic” of that topic. Aside from the very small top-n, this long tail consists of the vast majority of the vocabulary. Only a relatively small number of top-n elements are up-weighted enough to “characterize” the topic. So, while a single element/topic delta scalar measurement may work at the highest level of the whole model, inspecting stability and convergence down at the topic level is more difficult via difference analysis because of the sampling noise. In other words, the majority of element vocabulary in any topic is more subject to sampling noise than the very small number of top-n elements. Conversely, the top-n is much less subject to sampling noise. So, watching all vocabulary element/topic assignment differences at the individual topic level includes all of that tail noise to overwhelm the individual topics' top-n training convergence signals.

Up at the complete model level, counting element/topic assignment deltas can overcome the sampling noise (it has to, or the model is not learning). But, counting element/topic assignment deltas down at the topic level means that the long tail in each topic, which entails the majority of the vocabulary, also contributes most of the noise to each topic's learning signal.

Therefore, only the differences/similarities of the top-n elements in each topic are selected and monitored as the top-n is the model's self-selected least-noisy signal. This top-n differences/similarity approach is differentiated over how LDA training progress is typically viewed.

While training of the topic modeler 160 may progress through a number of training iterations and documents, in various embodiments it may remain unclear whether training of the various topics 162 converge for some or all of the topics. Therefore, unsupervised machine learning may benefit from an ability to measure training progress of the topic modeling system 100. Thus, in various embodiments a stability monitor 170 may be employed.

The stability monitor 170 may monitor stability and convergence of the topic modeler 160 and provide metrics of stability and convergence for analysis and/or visualization to a client 190 of the topic modeling system to determine the effectiveness and progress of topic model training, in various embodiments. The stability monitor 170 may communicate with the client 190 over various programmatic interfaces or Application Programming Interfaces (APIs), not shown, to provide this analysis and/or visualization. The stability monitor 170 may send various messages via these APIs to the client, where the messages may be formatted according to a particular markup language such as Extensible Markup Language (XML), JavaScript Object Notation (JSON), Hypertext Transfer Protocol (HTTP) and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP). In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

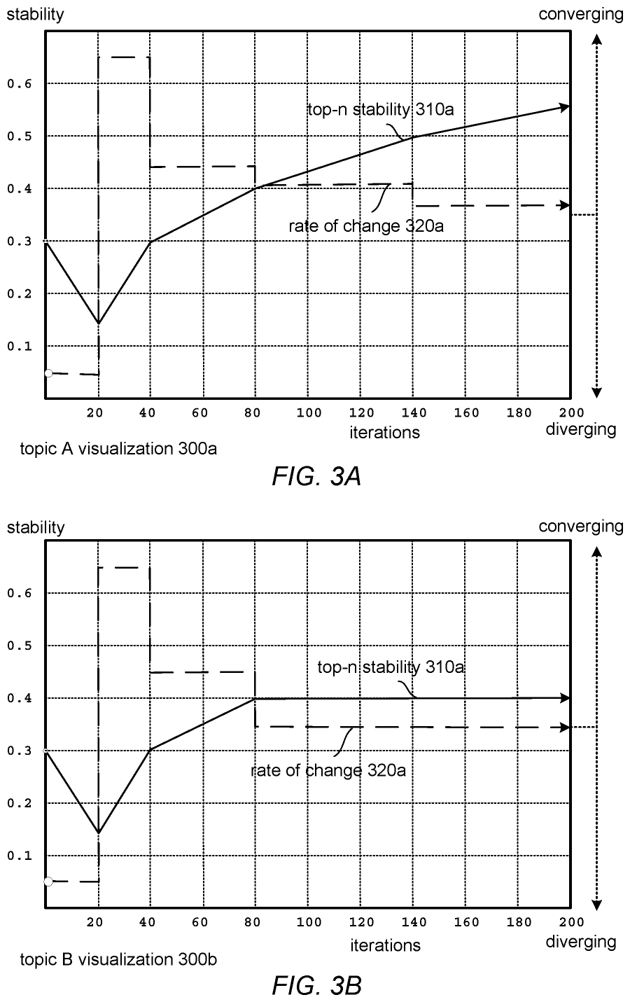

Interactions with the client 190 are discussed in greater detail below in FIGS. 3A and 3B. While, in some embodiments, the stability monitor 170 may interact with the client, it should be understood that interactions with a client in some embodiments are not necessary or required, and instead various metrics 174 may be used to guide training of the topic model without interaction with the client 190. For example, the generated metrics 174 may show how many training iterations are needed to move from random initialization state to learned state. This information may then be used to automatically select an efficient training iteration count or a training hyper-parameter. Thus, it should be understood that various analysis and visualization techniques using the generated metrics 174 are merely examples and are not intended to be limiting.

The stability monitor 170 may communicate with the topic modeler 160 to obtain, for respective training iterations and topics, probability distributions 164 in order to build a history 176, in various embodiments. This history may take a number of forms. In some embodiments, this history may include probability distributions for various topics for each of a series of training iterations. By accumulating a history of probability distributions, training of the topic model may proceed asynchronously with respect to analysis and visualization, allowing analysis and visualization to be performed at any time, including after all training has been completed. In other embodiments, the stability monitor 170 may operate more closely coupled with the training iterations of the topic modeler 160 such that the stability monitor employs the similarity function 178 to derive metrics for respective training iterations as the training iterations are performed. In these embodiments, the history 176 may be composed of a small number of probability distributions, including distributions for topics of a current training iteration and a previous training iteration, and also include an accumulation of stability metrics 174 and potentially other metrics, in some embodiments in the form of various time series metrics such as time series stability metrics and time series convergence metrics. It should be understood that these are merely examples of potential embodiments and, as the topic modeler 160 and stability monitor 170 may execute asynchronously, various embodiments may be envisioned.

To generate a stability metric for a topic and training iteration, the stability monitor 170 may first obtain, from the topic modeler 160, respective probability distributions 164 for the topic for the training iteration and for a previous training iteration. For this reason, the topic modeler may first execute one or more initial training iterations for which stability metrics will not be available. A stability metric may then be generated for a training iteration subsequent to a first training iteration of training of the topic model 142.

Once probability distributions for the topic for the training iteration and for a previous training iteration have been obtained, the stability monitor 170 may select only the top elements whose most probabilities in the topic's vocabulary distribution are greater or higher than probabilities of association for elements that are not selected. The choice of an effective top-n value or size might vary with the model's overall vocabulary size and with the nature of the training documents. Too low of a top-n value may appear to stabilize too quickly and may not show much training progression or detailed dynamics. However, too high of a top-n value (i.e. including more of the long vocabulary tail) can easily demonstrate the sampling noise. Topic models often have a vocabulary size in the tens to perhaps hundreds of thousands of elements. So, a top-n value of only in the hundreds is a drastically smaller number of differences to follow vs tracking the differences of the whole vocabulary. This makes the convergence and stability measure quick to compute.

A number of selected elements may be fixed, with the specific number of selected elements chosen such that sampling noise will, progressively over training iterations, suppress sampling noise beyond a threshold value. Thus, the number of selected elements may be chosen in a number of ways. In some embodiments the number may simply be set as a constant value based on observed experience training various topic models or may be set as constant with respect to domain-specific topics. In other embodiments, a client such as the client 190 may set the number of selected topics while in yet other embodiments, the number of selected topics may be set to exclude elements that include sampling noise above a threshold value or amount. Those of ordinary skill in the art should understand that these are merely examples of setting the number of selected topics, that any number of techniques for setting the number of selected topics may be employed and that these examples are not intended to be limiting.

Once a top-n number of elements have been selected for the training iteration and a previous training iteration, where n represents the number of selected elements, the stability monitor 170 may employ the similarity function 178 to generate a stability metric for the topic to be included in the metrics 174. This similarity function results in a scalar measure of convergence and stability for the topic for the training iteration in training. Lower similarity metrics indicate more differences between the two training iterations (lower convergence and lower stability) and higher similarity measures indicate more convergence and more stability between the two training iterations.

In practice, any useful similarity metric function could be employed to compare the current training iterations' topics' top-n most probable elements to the previous training iteration's top-n elements. In various embodiments, the similarity measure may be computed as a value between 0.0 and 1.0 inclusive via:

1.0−(Δcount/top-n value)

In some embodiments, an unordered comparison may be used, where the unordered set comparisons ignore differences in position within the top-n elements. In other embodiments, an ordered comparison may be used, providing a more comparison that tends to lower the similarity measures overall. This ordered comparison includes top-n position changes as countable differences. Accordingly, the ordered similarity measure may provide more sensitive convergence and stability measurements in some embodiments. It should be understood that these are merely examples of similarity functions and are not intended to be limiting.

Once similarity measures/metrics for each of topic of the model have been determined for the training iteration, these measures may be added to the history 176. Furthermore, additional metrics may be derived from similarity measures. For example, collective similarity measures for a series of training iterations may be accumulated to produce a time series of similarity measures, in some embodiments. In addition, multiple similarity measures of multiple training iterations, or the time series of similarity measures, may be analyzed to determine a rate of change of similarity or a convergence or divergence metric, in various embodiments. Furthermore, derived metrics may be represented as time series, such as a time series rate of change or time series convergence or divergence, in various embodiments. Furthermore, these various derived metrics may be determined by pairs of similarity measures of adjacent training iterations or, in some embodiments, be determined using weighted values of a set of training iterations. Once the similarity measures and other derived metrics have been generated, they may be used by the visualizer 172 or be used as input for analysis/visualization as discussed above.

The method's time series measurements may be useful for differentiating strongly converging topics vs weakly converging topics. The measures also provide actionable information for identifying and debugging individual topics which converge poorly. Further, these measures can also be useful for selecting LDA training hyper-parameters (e.g. training iteration count).

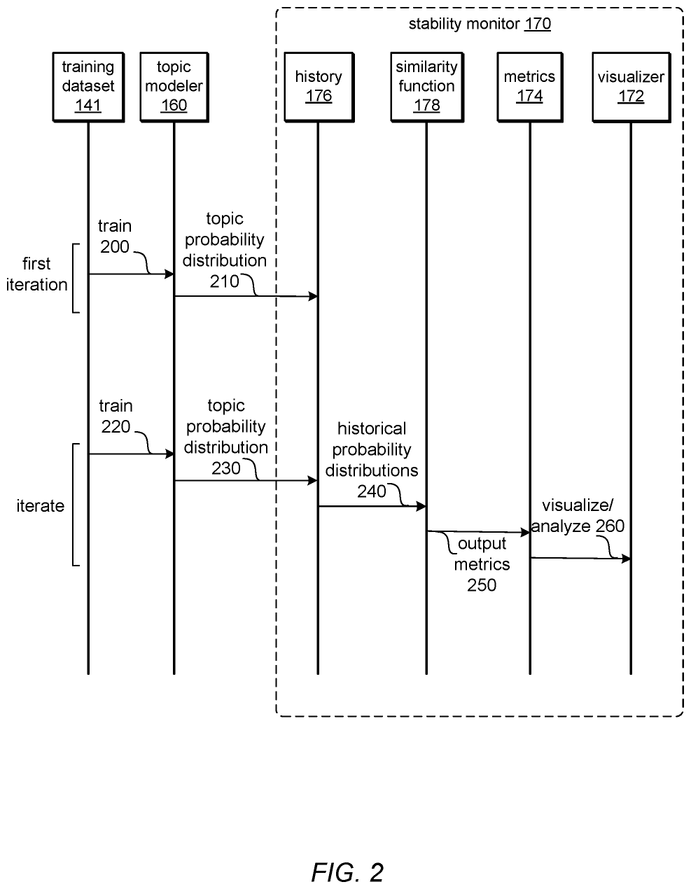

FIG. 2 is a sequence diagram illustrating training of a topic modeling system that implements stability monitoring, in various embodiments. To generate stability metrics, the stability monitor 170 may first obtain, from the topic modeler 160, respective probability distributions 164 for various topics for a training iteration and for a previous training iteration. For this reason, the topic modeler may first execute one or more initial training iterations for which stability metrics will not be available. A stability metric may then be generated for a training iteration subsequent to a first training iteration of training of topic model. As shown in 200, a training operation may be performed by the topic modeler 160 based on training documents received from training dataset 141, in various embodiments. Upon completion of this training, the topic modeler 160 may provide topic probability distributions 210 for the various topics for at least a first training iteration to the history 176 of the stability monitor 170, in various embodiments.

Then, training and monitoring may proceed over multiple training iterations. As shown in 220, a training operation may be performed by the topic modeler 160 based on training documents received from training dataset 141, in various embodiments. Upon completion of this training, the topic modeler 160 may provide topic probability distributions 230 for the various topics for at least a first training iteration to the history 176 of the stability monitor 170, in various embodiments. Upon receipt of the topic probability distributions, the stability monitor 170 may employ historical probability distributions 240 of multiple training iterations for each topic to generate similarity metrics using a similarity function 178. The stability monitor 170 may select only top elements whose probabilities of association with the topic are greater or higher than probabilities of association for elements that are not selected. The choice of an effective top-n value or size might vary with the model's overall vocabulary size and with the nature of the training documents. Too low of a top-n value may appear to stabilize too quickly and may not show much training progression or detailed dynamics. However, too high of a top-n value (i.e. including more of the long vocabulary tail) can easily demonstrate the sampling noise. Topic models often have a vocabulary size in the tens to perhaps hundreds of thousands of elements. So, a top-n value of only in the hundreds is a drastically smaller number of differences to follow vs tracking the differences of the whole vocabulary. This makes the convergence and stability measure quick to compute.

Once a top-n number of elements have been selected for the historical probability distributions, where n represents the number of selected elements, the stability monitor 170 may employ the similarity function 178 to generate a stability metric for the topic to be included in the metrics 174. This similarity function results in a scalar measure of convergence and stability for the topic for the training iteration in training. Lower similarity metrics indicate more differences between the two training iterations (lower convergence and lower stability) and higher similarity measures indicate more convergence and more stability between the two training iterations. Additional metrics may also be derived from the similarity measures. For example, collective similarity measures for a series of training iterations may be accumulated to produce a time series of similarity measures, in some embodiments. In addition, multiple similarity measures of multiple training iterations, or the time series of similarity measures, may be analyzed to determine a rate of change of similarity or a convergence or divergence metric, in various embodiments. Furthermore, derived metrics may be represented as time series, such as a time series rate of change or time series convergence or divergence, in various embodiments. Furthermore, these various derived metrics may be determined by pairs of similarity measures of adjacent training iterations or, in some embodiments, be determined using weighted values of a set of training iterations. Once the similarity measures and other derived metrics have been generated, they may be output as metrics 250 to the metrices 174.

Then, output metrics may be used as input for visualization and analysis 260 as discussed above. Visualization and analysis interactions are discussed in greater detail below in FIGS. 3A and 3B.

FIG. 3A is a diagram illustrating stability and convergence for a topic during training of a topic modeling system where the topic converges, in various embodiments. A topic, referred to as topic A, may have a visualization 300a. This visualization may be useful to understand how the various metrics generated by a stability monitor, such as the stability monitor 170 of FIG. 1, may be used to evaluate convergence of training of a topic modeler with respect to the topic A. The visualization shows a top-n stability measure 310a and a rate of change metric 320a over a series of training iterations shown on the horizontal axis of a graph. An initial region of training iterations, from training iteration 0 to training iteration 80 in this example, shows an initial training where the topic model transitions from an initial state to obtaining an increasingly leaned representation of hidden structure of topic A in the training documents. Then, as training iterations proceed beyond training iteration 80, stability steadily improves as indicated by top-n stability measure 310a steadily increasing. Meanwhile, rate of change 320a, after initial training, settles into a steady, positive value indicating convergence of training for the topic.

FIG. 3B is a diagram illustrating stability and convergence for a topic during training of a topic modeling system where the topic fails to increasingly converge, in various embodiments. A topic, referred to as topic B, may have a visualization 300b. This visualization may be useful to understand how the various metrics generated by a stability monitor, such as the stability monitor 170 of FIG. 1, may be used to determine a failure to achieve higher stability or convergence of training of a topic modeler with respect to the topic B. The visualization shows a top-n stability measure 310b and a rate of change metric 320 over a series of training iterations shown on the horizontal axis of a graph. An initial region of training iterations, from training iteration 0 to training iteration 80 in this example, shows an initial training where the topic model transitions from an initial state to obtaining an increasingly leaned representation of hidden structure of topic B in the training documents. Then, unlike topic A of FIG. 3A above, as training iterations proceed beyond training iteration 80, stability does not improve as indicated by top-n stability measure 310b failing to increase. Meanwhile, rate of change 320b, after initial training, settles into a zero or negative average value indicating lack of convergence of training for the topic.

It should be understood that FIGS. 3A and 3B are examples of stability and rate of change metrics for topics that are greatly simplified for clarity of presentation. Real world examples of topic stability, however, though more complex may show similar trends over training iterations, in various embodiments. Furthermore, while these figures show merely two example topics, practical embodiments may have tens or hundreds of topics to visualize. As a result, in some embodiments more complex presentations such as three-dimensional graphs using topics as a third dimension may be employed. Furthermore, these visualizations may be provided to clients, such as the client 190 of FIG. 1, in a variety of ways. For example, in some embodiments, various metrics may be made available to a client Graphical User Interface (GUI) visualization application via one or more APIs such as discussed above in FIG. 1, while in other embodiments may employ visualizations in the form of graphs displayed as web page using an HTTP protocol, where the topic modeling system, such as the topic modeling system 100 of FIG. 1, may be implemented as a service of a cloud or service provider network. Those of ordinary skill in the art should understand that these are merely examples of visualization techniques and that any number of such techniques may be employed, in various embodiments.

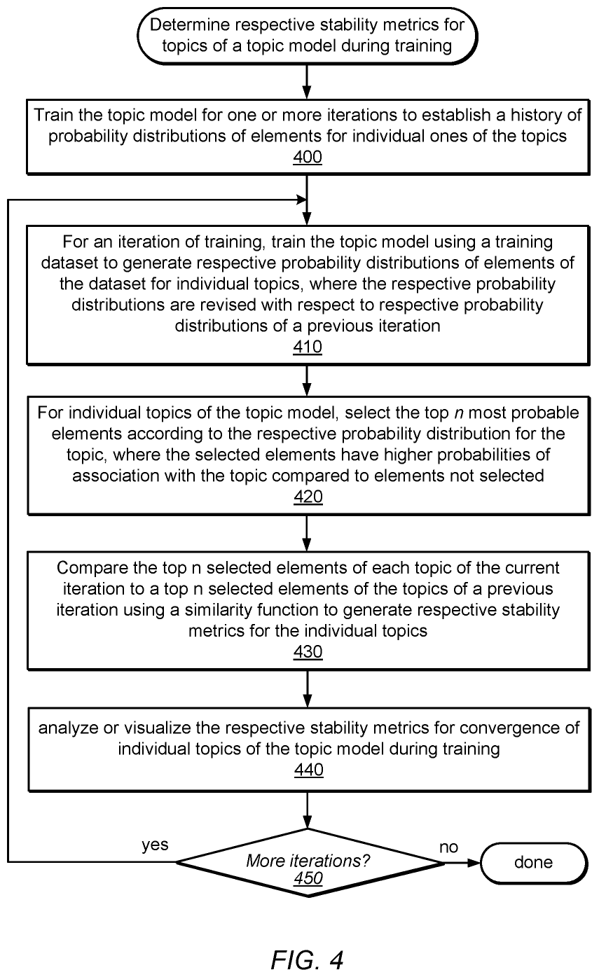

FIG. 4 is a flow diagram illustrating an embodiment of determining respective stability metrics for topics of a topic model during training of the model, in some embodiments. The process begins at 400, where a topic model, such as the topic model 142 of FIG. 1, is trained using documents of a dataset, such as the unlabeled training dataset 141 of FIG. 1, for at least one, first training iteration of training to establish a history of probability distributions, such as the probability distributions 164 of FIG. 1, of elements for individual ones of topics, such as the topics 162 of FIG. 1, of the topic model, according to various embodiments. An example of such initial training iteration(s) is shown in steps 200 and 210 of FIG. 2.

Then, as shown in 410, for a current training iteration of training, the topic model is again trained using documents of the dataset to generate respective probability distributions of model vocabulary for individual ones of the topics, where the respective probability distributions are revised with respect to respective probability distributions of a previous training iteration. An example of such training is shown in step 220 of FIG. 2.

Then, as shown in 420, for individual topics of the topic model and for each of the current and previous training iterations, top-n elements whose probabilities of association with the respective topic are greater or higher than probabilities of association for elements that are not selected. The choice of an effective top-n value or size might vary with the model's overall vocabulary size and with the nature of the training documents. Too low of a top-n value may appear to stabilize too quickly and may not show much training progression or detailed dynamics. However, too high of a top-n value (i.e. including more of the long vocabulary tail) can easily demonstrate the sampling noise. Topic models often have a vocabulary size in the tens to perhaps hundreds of thousands of elements. So, a top-n value of only in the hundreds is a drastically smaller number of differences to follow vs tracking the differences of the whole vocabulary. This makes the convergence and stability measure quick to compute.

Then, as shown in 430, once a top-n number of elements have been selected from the probability distributions of the current and previous training iterations, where n represents the number of selected elements, a similarity function, such as the similarity function 178 of FIG. 1, may be employed to generate a stability metric for the topic by comparing the selected elements if the current and previous training iterations. This similarity function results in a scalar measure of convergence and stability for the topic for the training iteration in training. Lower similarity metrics indicate more differences between the two training iterations (lower convergence and lower stability) and higher similarity measures indicate more convergence and more stability between the two training iterations. Additional metrics may also be derived from the similarity measures. For example, collective similarity measures for a series of training iterations may be accumulated to produce a time series of similarity measures, in some embodiments. In addition, multiple similarity measures of multiple training iterations, or the time series of similarity measures, may be analyzed to determine a rate of change of similarity or a convergence or divergence metric, in various embodiments. Furthermore, derived metrics may be represented as time series, such as a time series rate of change or time series convergence or divergence, in various embodiments. Furthermore, these various derived metrics may be determined by pairs of similarity measures of adjacent training iterations or, in some embodiments, be determined using weighted values of a set of training iterations.

Then, as shown in 440, in some embodiments the generated stability metrics and other metrics may be analyzed and/or visualized to determine convergence of individual topics of the topic model during training. It should be understood that step 440 may, in some embodiments be performed for some training iterations of training while not being performed for others, therefore step 440 should be considered an optional step for any particular training iteration of training, and that training overall may include relatively few, or even a single, analysis or visualization step regardless of the number of total training iterations. Visualization is discussed in further detail above in FIGS. 3A and 3B.

Then, as shown in 450, a determination may be made whether more training iterations are needed. In some embodiments, this determination may be made using the respective stability metrics or other derived metrics for convergence while in other embodiments this determination may be made for any number of other reasons. If additional training iterations are needed, as indicated by a positive exit from 450, the process may return to 410. If additional training iterations are not needed, as indicated by a negative exit from 450, the process is then complete.

Any of various computer systems may be configured to implement processes associated with a technique for multi-region, multi-primary data store replication as discussed with regard to the various figures above. FIG. 5 is a block diagram illustrating one embodiment of a computer system suitable for implementing some or all of the techniques and systems described herein. In some cases, a host computer system may host multiple virtual instances that implement the servers, request routers, storage services, control systems or client(s). However, the techniques described herein may be executed in any suitable computer environment (e.g., a cloud computing environment, as a network-based service, in an enterprise environment, etc.).

Various ones of the illustrated embodiments may include one or more computer systems 2000 such as that illustrated in FIG. 5 or one or more components of the computer system 2000 that function in a same or similar way as described for the computer system 2000.

In the illustrated embodiment, computer system 2000 includes one or more processors 2010 coupled to a system memory 2020 via an input/output (I/O) interface 2030. Computer system 2000 further includes a network interface 2040 coupled to I/O interface 2030. In some embodiments, computer system 2000 may be illustrative of servers implementing enterprise logic or downloadable applications, while in other embodiments servers may include more, fewer, or different elements than computer system 2000.

Computer system 2000 includes one or more processors 2010 (any of which may include multiple cores, which may be single or multi-threaded) coupled to a system memory 2020 via an input/output (I/O) interface 2030. Computer system 2000 further includes a network interface 2040 coupled to I/O interface 2030. In various embodiments, computer system 2000 may be a uniprocessor system including one processor 2010, or a multiprocessor system including several processors 2010 (e.g., two, four, eight, or another suitable number). Processors 2010 may be any suitable processors capable of executing instructions. For example, in various embodiments, processors 2010 may be general-purpose or embedded processors implementing any of a variety of instruction set architectures (ISAs), such as the ×86, PowerPC, SPARC, or MIPS ISAs, or any other suitable ISA. In multiprocessor systems, each of processors 2010 may commonly, but not necessarily, implement the same ISA. The computer system 2000 also includes one or more network communication devices (e.g., network interface 2040) for communicating with other systems and/or components over a communications network (e.g. Internet, LAN, etc.). For example, a client application executing on system 2000 may use network interface 2040 to communicate with a server application executing on a single server or on a cluster of servers that implement one or more of the components of the embodiments described herein. In another example, an instance of a server application executing on computer system 2000 may use network interface 2040 to communicate with other instances of the server application (or another server application) that may be implemented on other computer systems (e.g., computer systems 2090).

System memory 2020 may store instructions and data accessible by processor 2010. In various embodiments, system memory 2020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above for a topic modeling system as indicated at 2026, for the downloadable software or provider network are shown stored within system memory 2020 as program instructions 2025. In some embodiments, system memory 2020 may include data store 2045 which may be configured as described herein.

In some embodiments, system memory 2020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 2000 via I/O interface 2030. A computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. Further, a computer-accessible medium may include transmission media or signals such as electrical, electromagnetic, or digital signals, conveyed via a communication medium such as a network and/or a wireless link, such as may be implemented via network interface 2040.

In one embodiment, I/O interface 2030 may coordinate I/O traffic between processor 2010, system memory 2020 and any peripheral devices in the system, including through network interface 2040 or other peripheral interfaces. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments, some or all of the functionality of I/O interface 2030, such as an interface to system memory 2020, may be incorporated directly into processor 2010.

Network interface 2040 may allow data to be exchanged between computer system 2000 and other devices attached to a network, such as between a client device and other computer systems, or among hosts, for example. In particular, network interface 2040 may allow communication between computer system 800 and/or various other device 2060 (e.g., I/O devices). Other devices 2060 may include scanning devices, display devices, input devices and/or other communication devices, as described herein. Network interface 2040 may commonly support one or more wireless networking protocols (e.g., Wi-Fi/IEEE 802.7, or another wireless networking standard). However, in various embodiments, network interface 2040 may support communication via any suitable wired or wireless general data networks, such as other types of Ethernet networks, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 2000, including one or more processors 2010 and various other devices (though in some embodiments, a computer system 2000 implementing an I/O device 2050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with the computer system 2000. In general, an I/O device (e.g., cursor control device, keyboard, or display(s) may be any device that can communicate with elements of computing system 2000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of decentralized application development and deployment as described herein may be executed on one or more computer systems, which may interact with various other devices. FIG. 5 is a block diagram illustrating an example computer system, according to various embodiments. For example, computer system 2000 may be configured to implement nodes of a compute cluster, a distributed key value data store, and/or a client, in different embodiments. Computer system 2000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 2000 also includes one or more persistent storage devices 2060 and/or one or more I/O devices 2080. In various embodiments, persistent storage devices 2060 may correspond to disk drives, tape drives, solid state memory, other mass storage devices, or any other persistent storage device. Computer system 2000 (or a distributed application or operating system operating thereon) may store instructions and/or data in persistent storage devices 2060, as desired, and may retrieve the stored instruction and/or data as needed. For example, in some embodiments, computer system 2000 may be a storage host, and persistent storage 2060 may include the SSDs attached to that server node.

In some embodiments, program instructions 2025 may include instructions executable to implement an operating system (not shown), which may be any of various operating systems, such as UNIX, LINUX, Solaris™, MacOS™, Windows™, etc. Any or all of program instructions 2025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2000 via I/O interface 2030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2040.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

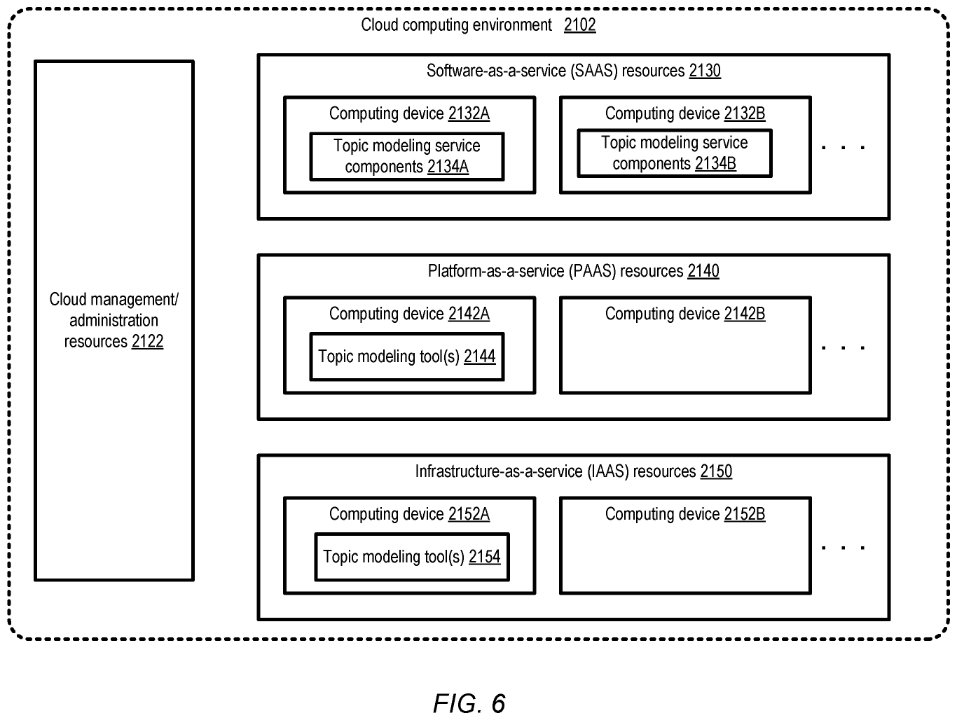

FIG. 6 illustrates an example cloud computing environment whose resources may be employed to implement a topic modeling system that includes stability monitoring, according to at least some embodiments. As shown, cloud computing environment 2102 may include cloud management/administration resources 2122, software-as-a-service (SAAS) resources 2130, platform-as-a-service (PAAS) resources 2140 and/or infrastructure-as-a-service (IAAS) resources 2150. Individual ones of these subcomponents of the cloud computing environment 2102 may include a plurality of computing devices (e.g., devices similar to device 2000 shown in FIG. 5) distributed among one or more data centers in the depicted embodiment, such as devices 2132A, 2132B, 2142A, 2142B, 2152A, 2152B and the like. A number of different types of network-accessible services, such as topic modeling services, database services, customer-relationship management services, machine learning services and the like may be implemented using the resources of the cloud computing environment in various embodiments.

In the depicted embodiment, clients or customers of the cloud computing environment 2102 may choose the mode in which they wish to utilize one or more of the network-accessible services offered. For example, in the IAAS mode, in some embodiments the cloud computing environment may manage virtualization, servers, storage and networking on behalf of the clients, but the clients may have to manage operating systems, middleware, data, runtimes, and applications. If, for example, a client wishes to use IAAS resources 2150 for topic modeling, the clients may identify one or more virtual machines implemented using computing devices 2152 (e.g., 2152A or 2152B) as the platforms on which the topic modeling tool(s) 2154 (e.g., the topic modeler and/or topic modeling presentation tools similar to those discussed above) are to be run, download the tools, and issue commands to perform topic modeling via programmatic interfaces provided by the cloud computing environment.

In the PAAS mode, clients may be responsible for managing a smaller subset of the software/hardware stack in various embodiments: e.g., while the clients may still be responsible for application and data management, the cloud environment may manage virtualization, servers, storage, network, operating systems as well as middleware. Topic modeling tools 2144 may be deployed to, and run at, PAAS resources (e.g., 2142A, 2142B etc.) as applications managed by various clients in different embodiments. In the SAAS mode, the cloud computing environment may offer topic modeling as a pre-packaged service, managing even more of the software/hardware stack in various embodiments—e.g., clients may not even have to explicitly manage applications or data. Instead, for example, with respect to topic modeling functionality of the kind discussed above, clients may simply indicate (e.g., via programmatic interfaces) unlabeled datasets and the SAAS resources may utilize topic modeling service components 2134 (e.g., 2134A or 2134B) pre-installed on computing devices 2132 to generate, store, and display topic models as desired.

The administration resources 2122 may perform resource management-related operations (such as provisioning, network connectivity, ensuring fault tolerance and high availability, and the like) for all the different modes of cloud computing that may be supported in various embodiments. Clients may interact with various portions of the cloud computing environment using a variety of programmatic interfaces in different embodiments, such as a set of APIs (application programming interfaces), web-based consoles, command-line tools, graphical user interfaces and the like. Note that other modes of providing services (including topic modeling services) may be supported in at least some embodiments, such as hybrid public-private clouds and the like.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed:

1. A method, comprising:
determining, for one or more topics of a plurality of topics, respective stability metrics for individual ones of a plurality of iterations of training of a topic model, wherein the training comprises a first iteration and the plurality of iterations, wherein the plurality of iterations are subsequent to the first iteration, and wherein, for individual topics of the one or more topics, an iteration of the plurality of iterations comprises:
selecting a number of elements according to respective probabilities assigned to individual ones of a plurality of elements of a vocabulary of a training set during training of the topic model for the iteration, wherein the selected elements have respective higher probabilities of association with the individual topics than other elements of the plurality of elements that are not selected; and
comparing the selected elements of the iteration to previously selected elements of another iteration previous to the iteration, according to a similarity function, to generate the respective stability metric for the individual topic.

2. The method of claim 1, wherein the similarity function indicates a similarity between the iteration and the other iteration inversely proportional to respective differences between respective probabilities assigned to the selected elements and the previously selected elements.

3. The method of claim 1, further comprising, for individual topics of the one or more topics, comparing respective stability metrics for the iteration and another iteration of the plurality of iterations to generate a convergence metric, wherein the convergence metric indicates a measure of convergence of training of the topic model for the individual topic.

4. The method of claim 1, wherein an iteration of the plurality of iterations further comprises training the topic model on the training set to assign respective probabilities to individual ones of the plurality of elements of the training set.

5. The method of claim 1, wherein the number of elements selected is specified to exclude elements with respective assigned probabilities that comprise sampling noise above a threshold value.

6. The method of claim 1, wherein, for individual ones of the one or more topics, the respective stability metrics generated for individual ones of the plurality of iterations collective form respective time series stability metrics.

7. The method of claim 6, further comprising:
analyzing, for a topic of the one or more topics, the time series stability metrics for the topic to determine that the topic converges for training of the topic model, wherein the analyzing comprises comparing, for a portion of the time series stability metrics, individual values of adjacent ones of the respective time series stability metric to generate a time series convergence metric for the topic, and wherein determining that topic converges for training of the topic model comprises determining that the time series convergence metric meets a threshold value.

8. One or more non-transitory, computer-readable storage media, storing program instructions that when executed on or across a plurality of computing devices, cause the plurality of computing devices to train a topic model, comprising:
determining respective stability metrics for one or more topics of a plurality of topics during training of a topic model, wherein the training comprises a first iteration and a plurality of iterations subsequent to the first iteration, and wherein an iteration of the plurality of iterations comprises:
training the topic model on a training set to assign respective probabilities to individual ones of a plurality of elements of a vocabulary of the training set, wherein the respective probabilities represent respective probabilities of association to respective topics of the plurality of topics for the respective elements; and
for individual topics of the one or more topics:
selecting a number of elements according to the respective assigned probabilities of the elements, the selected elements having respective higher probabilities of association with the individual topics than other elements of the plurality of elements that are not selected; and
comparing the selected elements of the iteration to previously selected elements of another iteration previous to the iteration, according to a similarity function, to generate the respective stability metric for the individual topic.

9. The one or more non-transitory, computer-readable storage media of claim 8, wherein the similarity function indicates a similarity between the iteration and the other iteration inversely proportional to respective differences between respective probabilities assigned to the selected elements and the previously selected elements.

10. The one or more non-transitory, computer-readable storage media of claim 8, wherein training the topic model further comprises, for individual topics of the one or more topics, comparing respective stability metrics for the iteration and another iteration of the plurality of iterations to generate a convergence metric, wherein the convergence metric indicates a measure of convergence of training of the topic model for the individual topic.

11. The one or more non-transitory, computer-readable storage media of claim 8, wherein, for individual ones of the one or more topics, the respective stability metrics generated for individual ones of the plurality of iterations collective form respective time series stability metrics.

12. The one or more non-transitory, computer-readable storage media of claim 8, wherein the number of elements selected is specified to exclude elements with respective assigned probabilities that comprise sampling noise above a threshold value.

13. The one or more non-transitory, computer-readable storage media of claim 8, wherein the number of elements selected is specified as a hyperparameter of the training of the topic model.

14. The one or more non-transitory, computer-readable storage media of claim 8, wherein training the topic model further comprises:
analyzing, for a topic of the one or more topics, the time series stability metrics for the topic to determine that the topic converges for training of the topic model, wherein the analyzing comprises comparing, for a portion of the time series stability metrics, individual values of adjacent ones of the respective time series stability metric to generate a time series convergence metric for the topic, and wherein determining that topic converges for training of the topic model comprises determining that the time series convergence metric meets a threshold value.

15. A system, comprising:
a machine learning system comprising at least one processor and a memory, configured to:
determine respective stability metrics for one or more topics of a plurality of topics during training of a topic model, wherein the training comprises a first iteration and a plurality of iterations subsequent to the first iteration, and wherein to perform an iteration of the plurality of iterations the machine learning system is configured to:
train the topic model on a training set to assign respective probabilities to individual ones of a plurality of elements of a vocabulary of the training set, wherein the respective probabilities represent respective probabilities of association to respective topics of the plurality of topics for the respective elements; and
for individual topics of the one or more topics:
select a number of elements according to the respective assigned probabilities of the elements, the selected elements having respective higher probabilities of association with the individual topics than other elements of the plurality of elements that are not selected; and
compare the selected elements of the iteration to previously selected elements of another iteration previous to the iteration, according to a similarity function, to generate the respective stability metric for the individual topic.

16. The system of claim 15, wherein the similarity function indicates a similarity between the iteration and the other iteration inversely proportional to respective differences between respective probabilities assigned to the selected elements and the previously selected elements.

17. The system of claim 15, wherein the machine learning system is further configured to, for individual topics of the one or more topics, compare respective stability metrics for the iteration and another iteration of the plurality of iterations to generate a convergence metric, wherein the convergence metric indicates a measure of convergence of training of the topic model for the individual topic.

18. The system of claim 15, wherein, for individual ones of the one or more topics, the respective stability metrics generated for individual ones of the plurality of iterations collective form respective time series stability metrics.

19. The system of claim 15, wherein the number of elements selected is specified to exclude elements with respective assigned probabilities that comprise sampling noise above a threshold value.

20. The system of claim 15, wherein the number of elements selected is specified as a hyperparameter of the training of the topic model.
